(19) United States
(12) Patent Application Publication
(10) Pub. No.: US 2024/0251224 A1
(43) Pub. Date: Jul. 25, 2024

(54) SHARING TALKER ID ACROSS COMMUNICATIONS NETWORKS

(71) Applicant: Catalyst Communications Technologies, Inc., Forest, VA (US)

(72) Inventors: John M. Schools, Forest, VA (US); Robin Grier, Forest, VA (US)

(73) Assignee: Catalyst Communications Technologies, Inc., Forest, VA (US)

(21) Appl. No.: 18/419,651

(22) Filed: Jan. 23, 2024

Related U.S. Application Data
(60) Provisional application No. 63/468,284, filed on May 23, 2023.
(60) Provisional application No. 63/455,589, filed on Mar. 30, 2023.
(60) Provisional application No. 63/440,716, filed on Jan. 24, 2023.

(51) Int. Cl. H04W 4/10; H04W 4/16

(52) U.S. Cl. CPC H04W 4/10; H04W 4/16

(57) ABSTRACT

Techniques for communication based on sharing talker ID across communications networks are disclosed. Push-to-talk (PTT) over broadband services are provided over a first communications system. The first communications system includes a plurality of user devices. A Talker ID is associated with a first user device from the plurality of user devices on the first communications system. The Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the information message are displayed on the second user device.

### RELATED APPLICATIONS

This application claims the benefit of U.S. provisional patent application “Sharing Talker ID Across Communications Networks” Ser. No. 63/440,716, filed Jan. 24, 2023, “Communication Networks With Redundancy Diversity” Ser. No. 63/455,589, filed Mar. 30, 2023, and “Communications Networks Using Situational Inference” Ser. No. 63/468,284, filed May 23, 2023.

Each of the foregoing applications is hereby incorporated by reference in its entirety.

### FIELD OF ART

This application relates generally to communications and more particularly to sharing talker ID across communications networks.

### BACKGROUND

From its very earliest days, “wireless” communication has been used to transfer information between locations at various distances. The wireless communication techniques progressed from semaphores and signal fires to wireless systems that could be used both day and night. Numerous experiments were made to develop systems for the wireless transfer of information. Such early systems included the “photophone” which transferred audio using light. Electrical systems, such as those based on electromagnetic induction, were extensively researched for their communication capabilities. One such electromagnetic system was developed to couple a moving vehicle such as a train to nearby telegraph cables. These early electromagnetic systems were only useful over short distances. Other electrical systems investigated included wireless telegraphy. These wireless telegraphic systems were based on ideas such as sending a current through a medium, such as water or the ground. Again, these wireless systems were only useful over short distances. It was not until radio waves were used as a basis for the telegraphic systems that a major wireless breakthrough occurred. Based on radio waves, information could be transferred over both short distances and long distances, and to more than one recipient at a time. As a result, there was significant interest in using radio waves to communicate messages of various types, including routine messages, military messages, and emergency messages, among many other types.

Early radio wave transmitters and receivers were quite simple devices. The transmitter could include a spark gap that caused a spark to be generated between two electrodes. These transmitters generated a wide range of frequencies, including audio, radio, and even light. Signals generated by the spark gaps could be detected using a device called a coherer. This device used metal particles between two electrodes. When a signal was detected, the metal particles would form a bridge between the electrodes, enabling an electric current to flow. Radio transmission and reception were enhanced by the development of transmitters that could transmit on a selected frequency and receivers that could selectively detect that frequency. Thus, continuous wave or CW signals could be transmitted to relay Morse code messages. Advancements in modulation techniques that enabled transmission of audio signals were developed. These modulation techniques included amplitude modulation (AM), followed by frequency modulation (FM).

Radio-based transmission and reception techniques have continued to advance at a significant pace. These techniques have accessed higher and higher radio frequencies, providing a broader spectrum for sending and receiving wireless communications. Further, these techniques enable an increasing number of signals to be transmitted. New modulation techniques, both analog and digital, have also been developed. These techniques take advantage of the expanded radio frequency spectrum available for communication. Such modulation techniques include amplitude shift keying (ASK), frequency shift keying (FSK), and quadrature shift keying (QSK), among many variants. Perhaps the most interesting modulation technique is based on spread spectrum techniques. Originally developed to hinder both detection and jamming in military applications, spread spectrum techniques are now commonly used for civilian applications such as cellular telephony.

### SUMMARY

The radio spectrum, which includes a portion of the electromagnetic spectrum, is generally considered to include frequencies between 0 Hz (e.g., DC) and 3 THz. This wide spectrum is divided into sections or “bands”. The frequency bands can propagate to different distances around the earth and into space, so the frequency bands are assigned to different communications services. The assignment of the frequency bands to particular communications services is overseen by the International Telecommunication Union (ITU), governments, government agencies such as the Federal Communications Commission (FCC), and so on. Competition for the frequency bands is fierce. From time to time, auctions are held to sell of portions of a radio frequency (RF) band to commercial enterprises for purposes ranging from cellular communications to digital television, and to wireless devices such as microphones, among many other applications. Other RF bands are reserved for specific purposes such as business terrestrial communications, maritime communications, government communications, etc. Within a government band, for example, the band can be partitioned and assigned to various governmental agencies such as public safety, emergency services, the military, etc.

A result of assigning frequencies even within a band to different agencies is that there can be only limited or even no interoperability between the user devices used by the agencies. This situation can occur if the agencies use different communications systems. While there remain a few scenarios in which use of such divergent user devices remains desirable, e.g., to relieve network congestion or for security purposes, in general, device interoperability is highly desirable. Even so, providing device interoperability can be a resource intensive undertaking for developing and maintaining the interoperability capabilities. The interoperability between user devices can include not only enabling text, individual voice calls, and talkgroup calls, but also providing useful information such as Talker ID and critical information such as mission-critical data (MCData) as well. An information message such as a text message or an MCData message can be provided along with a communication from a first communications system. Since the user devices can usually handle text messages, then the Talker ID can be sent within a message for display of a user device associated with a second communications network. Additional information such as GPS data, other metadata, etc. can also be provided within the message. The GPS data can be rendered and displayed as GPS coordinates, a pin on a digital map, and so on.

Communications are accomplished based on sharing Talker ID across communications networks. Push-to-talk (PTT) services are provided over a first communications system, wherein the first communications system includes a plurality of user devices. The PTT services can be provided using various PTT-over-broadband capabilities. A Talker ID is associated with a first user device from the plurality of user devices on the first communications system, wherein the Talker ID uniquely identifies the first user device. A communication is sent, from the first user device to a second user device on a second communications system. An information message is provided from the first user device to the second user device, wherein the information message includes the Talker ID of the first user device. The communication and the information message are received on the second user device. The communication and the Talker ID associated with the first user device are displayed on the second user device.

Techniques for communication based on sharing talker ID across communications networks are disclosed. Push-to-talk (PTT) over broadband services are provided over a first communications system. The first communications system includes a plurality of user devices. A Talker ID is associated with a first user device from the plurality of user devices on the first communications system. The Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the information message are displayed on the second user device.

A computer-implemented method for communications is disclosed comprising: providing push-to-talk (PTT) services over a first communications system, wherein the first communications system includes a plurality of user devices; associating a Talker ID with a first user device from the plurality of user devices on the first communications system, wherein the Talker ID uniquely identifies the first user device; sending a communication from the first user device to a second user device on a second communications system; providing an information message, from the first user device to the second user device, wherein the information message includes the Talker ID of the first user device; receiving the communication and the information message on the second user device; and displaying, on the second user device, the communication and the Talker ID associated with the first user device. In embodiments, the communication is a text message, individual voice call, or talkgroup voice call. In embodiments, the receiving the communication and the information message is accomplished by a client application running on the second user device. In embodiments, the displaying further comprises replacing, by the client application running on the second user device, an ordinary user ID from the first communications system with the Talker ID associated with the first user device. In embodiments, the receiving the communication and the information message is accomplished by a standard PTT client. Some embodiments comprise showing text on the second user device, wherein the text includes the Talker ID associated with the first user device.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for sharing talker ID across communications networks.

FIG. 2 is a flow diagram for enabling the sharing of talker ID across communications networks.

FIG. 3 is an infographic for sending TID data via a text message.

FIG. 4 is an infographic for displaying TID data via a PTT client application.

FIG. 5 is an infographic for displaying TID data via a standard PTT client.

FIG. 6 is a system diagram for sharing talker ID across communications networks.

### DETAILED DESCRIPTION

Techniques for communications based on sharing Talker ID across communications networks are disclosed. The radio frequency (RF) spectrum, which is generally defined as 0 Hz to 3 THz, is divided into various bands. The bands have differing propagation characteristics, bandwidths, data transmission rates, and so on, and lend themselves to different communications capabilities. The extremely low frequency band (ELF) and very low frequency band (VLF), which can include frequencies between 3 Hz and 30 Hz and 3 kHz and 30 kHz respectively, can be used to communicate with submerged submarines. However, for these bands, antenna systems are very large and data transmission rates are very low. At the other end of the RF spectrum, microwaves, which can include frequencies between 1 GHz and 1000 GHZ (1 THz), can transmit very large amounts of data using small antennas or dishes. Microwave communications tend to be used for high bandwidth, line-of-sight applications over relatively short distances. Because of these vastly different capabilities, use of the various RF bands is regulated by international organizations such as the International Telecommunications Union (ITU), treaties among countries, individual governments, government agencies such as the Federal Communications Commission (FCC), and the like. There are many competing uses for the RF bands, including AM broadcast, shortwave, aviation, and government. Public safety, business, FM broadcast, digital television, emergency broadcast such as NOAA Weather Radio (NWR) All Hazards, cellular telephony, and satellite links, among many, many more also compete for RF bands.

Various services, such as fire, police, and emergency medical services, are often assigned different frequencies within a band. The assignments are made to reduce channel congestion, to enable communications to proceed without causing unnecessary or unrelated transmissions to interfere with the other services, and so on. Further, the frequencies can be assigned within different bands such as the very high frequency (VHF) and ultra-high frequency (UHF) bands. As a result, communications within a department or agency, let alone communications between departments and agencies, can be difficult or impossible. While ongoing progress is being made, particularly in the wake of the 9/11 terrorist attacks and Hurricane Katrina, interagency communications remain problematic. Law enforcement agencies, such as state and local police, FBI, and emergency medical services, still encounter interagency communication issues. These issues continue to hinder responses to emergency situations such as active shooter events. When communication between communications systems such as agency communications systems are enabled, communications such as text messages, individual voice calls, and talkgroup voice calls can be identified only as a common or generic user, rather than identifying the actual originator of the text message or voice call. In embodiments, information about a talker on an originating system (TOS) can be extremely useful.

Communications are accomplished based on sharing Talker ID across communications networks. Push-to-talk (PTT) services are provided over a first communications system. The PTT services can include text messaging, individual voice calls, and talkgroup voice calls. The first communications system includes a plurality of user devices. The user devices can include handheld transceivers (HTs), mobile transceivers, base station transceivers, software-defined radio (SDR) transceivers, and so on. A Talker ID is associated with a first user device from the plurality of user devices on the first communications system. The Talker ID uniquely identifies the first user device. A communication is sent from the first user device to a second user device on a second communications system. The communication can include a text message, an individual or talkgroup voice call, and the like. An information message is provided from the first user device to the second user device. The information message includes the Talker ID of the first user device. The information message can include a text message, a mission-critical data (MCData) message, etc. Mission-critical information can include attributes peculiar to mission-critical communication such as call priority/preemption and emergency status. The communication and the information message are received on the second user device. The receiving can be accomplished using a standard push-to-talk (PTT) client, a client application running on the second user device, etc. A standard push-to-talk (PTT) client can include a “standard-issue” client which makes no attempt to associate a TOS Talker ID embedded within a received information message, from the first device, with other communication traffic from the first user device. The communication and the Talker ID associated with the first user device are displayed on the second device. The displaying can include replacing an ordinary user ID with the Talker ID. The displaying can further include displaying additional information such as mission-critical information, GPS location information, etc. The information message can comprise a variety of message types and can be composed of one or more headers, body portions, and footers. In some embodiments, the information message is comprised of a plurality of frames.

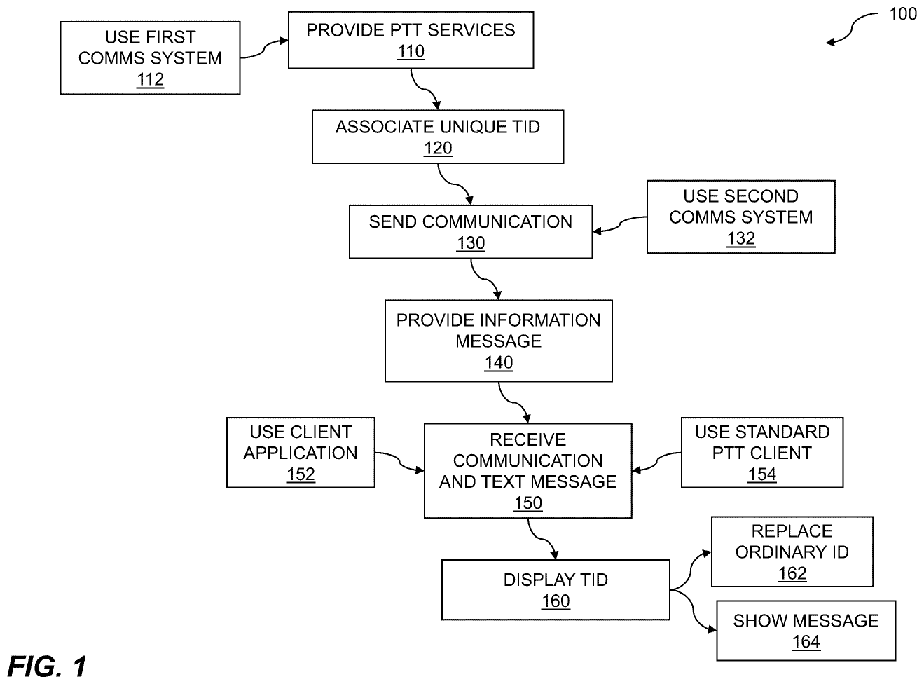

FIG. 1 is a flow diagram for sharing talker ID across communications networks. Communications systems can be established to enable the exchange of voice calls, text messages, and so on among users of the communications system. The users can include amateur radio operators; subscribers; team members associated with an organization or service such as public safety, government agencies, and emergency medical services; and so on. The communications systems can be accessed using a standard device configured to operate with the service, supplemental hardware, an application, and so on. A user of a first communications system can communicate with a user of a second communications system when there is a link established between the first communications system and the second communications system. The link can enable the transfer of text messages, individual calls, and talkgroup calls between the two communications systems. To ensure that accurate identification of a caller using a first device associated with one communications system is provided to one or more receivers using one or more second devices associated with a second communications system, key information can be provided in an information message. Upon receiving the communication and the information message at a second device using the second communications system, the communication and the contents of the information message can be displayed on the second device. The information that is displayed can include a Talker ID, GPS location, mission-critical information, and so on.

The flow 100 includes providing push-to-talk (PTT) services 110. A PTT service can enable two-way communication between a transmitting device and one or more receiving devices. The PTT service can be based on a communications model such as a half-duplex model. A half-duplex model can enable transmitting and receiving on a channel with one transmitter and one or more receivers. The PTT service can support one or more subaudible tones, tone codes, and so on. The tones can be used to open, squelch, or enable access to a channel, and so on. The PTT service can support a repeater operation, where a repeater operation can be based on a shift or offset between a transmitting frequency and a receiving frequency. In the flow 100, the PTT services are accomplished using a first communications system 112. In embodiments, the first communications system can be based on Land Mobile Radio technology (LMR). LMR technology can access assigned frequencies within radio frequency (RF) bands. The radio bands can include low-VHF, VHF, UHF bands, and so on. LMR radio technology can be used by public safety officers, emergency medical services, and the like. In embodiments, the first communications system can include a plurality of user devices. The user devices can include transceiver devices configured to operate with the first communications system. The user devices can include handheld transceiver (HT), mobile transceiver, and base station transceiver devices. The PTT service can be provided using various PTT over broadband capabilities.

The user devices can further include an add-on element such as a “dongle” or backpack element. In embodiments, the first user device is Third Generation Partnership Project (3GPP)-compliant. The user devices can further include a Long Term Evolution (LTE) device enabled using an application, app, code, and so on. In embodiments, the LTE technology can include 4G technology, 5G technology, and the like. Other 3GPP-compliant devices can include GSM, UMTS, IP Multimedia Subsystem (IMS), etc. The PTT services can enable voice calls, text messages, and so on. The PTT services can further include services that can be specific to a service, an agency, and so on. In embodiments, push-to-talk services comprise mission critical push-to-talk (MCPTT) services. MCPTT services can enable a PTT communication to reach a specific group of users. The group of users can include a team such as a team of first responders. MCPTT communications can be sent at substantially any time. MCPTT communications can be further enhanced based on communication precedence, priority, etc. The flow 100 includes associating a Talker ID 120 with a first user device from the plurality of user devices on the first communications system, wherein the Talker ID uniquely identifies the first user device. The Talker ID can include alphanumeric characters such as numbers, letters, special characters, and so on. The Talker ID can include a name, a caller ID, a team name, a team member number, a code, etc. In embodiments, the Talker ID can identify a talker on an originating system (TOS). The TOS identity can be particularly useful when communicating between or among two or more communications systems.

The flow 100 includes sending a communication 130 from the first user device to a second user device. The communication can include an LMR communication, an LTE communication, and so on. In embodiments, the communication can include a text message, individual voice call, or talkgroup voice call. The text message can include a standard text message such as an SMS message, a high priority message such as an MCData message, and the like. In the flow 100, the second user device uses a second communications system 132. The first communications system and the second communications system can include substantially similar communications systems, substantially different communications systems, etc. In embodiments, the first communications system and the second communications system can be based on Land Mobile Radio technology (LMR). The LMR system can include systems based on low-VHF, VHF, UHF, etc. systems. The first communications system and the second communications system can be based on substantially different technologies. In other embodiments, the first communications system can be based on LTE technology and the second communications system can be based on LMR technology. The LTE-based system and the LMR system can be accessed using a specialized application, standard hardware, etc. In other embodiments, the first communications system can be based on LMR technology, and the second communications system can be based on LTE technology. The communication can be sent to one or more individuals. In embodiments, the sending a communication can include a talk group on the second communications system.

The flow 100 includes providing an information message 140 from the first user device to the second user device, wherein the information message includes the Talker ID of the first user device. The information can include a message that can be compatible with the first communications system, the second communications system, and so on. In embodiments, the information message can include a text message. The text message can include one or more message formats or standards such as short message service (SMS), multimedia messaging service (MMS), an instant message, a notification such as a push notification, an app-generated or in-app message, a rich communication service (RCS) message, etc. In other embodiments, the information message can include an MCData message. The communication message can contain further information which can be associated with the Talker ID. In embodiments, the information message can include a GPS location. This GPS location can be included within a specific field within the information message. Other fields within the information message can include metadata and other types of data.

The flow 100 includes receiving the communication and the information message 150 on the second user device. The communication that is received can include a text message, an individual voice call, a talkgroup voice call, and so on. The receiving can be accomplished using a variety of techniques. In the flow 100, the receiving the communication and the information message is accomplished by a client application 152 running on the second user device. The client application can be downloaded over the Internet from a common source such as an “app store”. The client application can be preloaded onto a user device. The client application can be provided by an agency such as a government agency, a service such as a public safety service, and the like. In the flow 100, the receiving the communication and the information message is accomplished by a standard PTT client 154. In embodiments, the client application 152 is accomplished by a standard PTT client 154. The standard PTT client can include an unmodified client, a “standard issue” client, etc. Recall that the information message can include an MCData message. In embodiments, the receiving the communication and the information message can be accomplished by a client application running on the second user device. The MCData message can be handled differently from a text message. Embodiments can further include recognizing, by the client application, if the MCData message includes the Talker ID. If the MCData message includes the Talker ID, then the MCData message can be specially handled for display (discussed below). In other embodiments, the receiving the communication and the information message (e.g., an MCData message) can be accomplished by a standard PTT client.

The flow 100 includes displaying 160, on the second user device, the communication and the Talker ID associated with the first user device. The displaying can include rendering alphanumeric data, graphics, video, and so on. The displaying can be accomplished on a monochrome, grayscale, or color display associated with the second user device. In the flow 100, the displaying further includes replacing, by the client application running on the second user device, an ordinary user ID 162 from the first communications system with the Talker ID associated with the first user device. When a communication originating on a first user device accessing a first communications system is received by a second device accessing a second communications system, the Talker ID associated with the first user device can be displayed simply as a common or generic user on the second device. This loss of data can occur if the first communications system and the second communications system are being independently operated. By extracting the Talker ID from the information message received by the second user device, the correct Talker ID can be displayed. Message contents can also be displayed. The flow 100 further includes showing a message 164 on the second user device, wherein the message includes the Talker ID associated with the first user device. The message can include text, mission-critical text, and other information. In embodiments, the message can include a GPS location for the first user device. The GPS coordinates can be represented in a format that is not human readable or easily understood. Embodiments further include interpreting, by a client application, the GPS location. The interpreting can include converting the GPS data to digits, text, and the like. Further embodiments include showing, on the second user device, the GPS location of the first user device. The showing the GPS location can include showing GPS coordinates in degrees, minutes, and seconds; showing decimal GPS coordinates; displaying a pin on a digital map; etc. The location provided can include location information beyond that obtained from satellites, such as beacon information from within buildings along with various other positional information. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

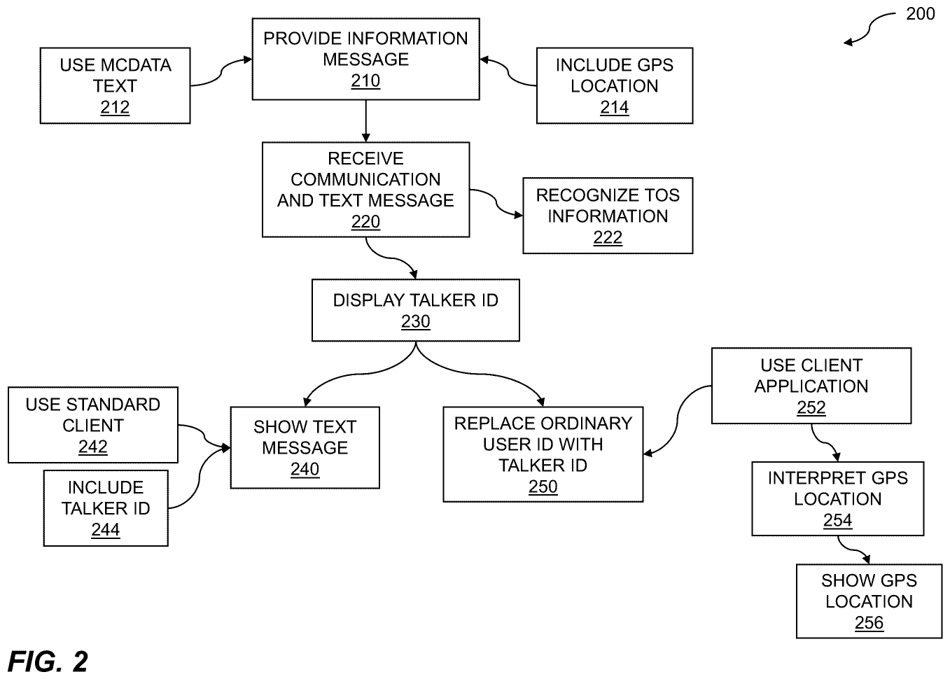

FIG. 2 is a flow diagram for enabling the sharing of talker ID across communications networks. Discussed throughout, enabling communication between user devices associated with independent communications systems is critical to effective communication during times of crisis such as natural disasters, terrorist attacks, and government actions. Such communication can be enabled by deep integration between the communications systems. Such deep integration is complex to implement and maintain, and is typically resisted by the operators of the communications systems because the systems are operated independently. Instead, capabilities of push-to-talk compliant clients and specialized apps can be used to send important information such as Talker ID and critical information such as mission-critical data. The Talker ID and the critical information can be provided in an information message. In addition to the Talker ID, other information such as GPS data can be included, thus providing additional information about a caller from a communications system which is different from the system receiving the call. Communications are enabled using sharing Talker ID across communications networks. Push-to-talk (PTT) services are provided over a first communications system, wherein the first communications system includes a plurality of user devices. A Talker ID is associated with a first user device from the plurality of user devices on the first communications system, wherein the Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the Talker ID associated with the first user device are displayed on the second device.

The flow 200 includes providing an information message 210. The information message can be provided in addition to sending a communication. In embodiments, the communication can include a text message, individual voice call, talkgroup voice call, file, file sharing link, image, or video. The information message can include a message based on a standard format, protocol, and so on. In embodiments, the information message can include a text message. The text message can include a format appropriate for reception by a standard push-to-talk client. In the flow 200, the information message can include an MCData message 212. The MCData message can include mission-critical information and additional information such as a Talker ID. Further information can be included in the text message or the MCData message. In the flow 200, the Talker ID is associated with a GPS location 214. In embodiments, the Talker ID includes Talker ID information and a GPS location information. The GPS location information can be used to confirm a location associated with the Talker ID and to enable access to the communications system based on location, communication between or among user devices on different communications systems, etc.

The flow 200 includes receiving 220 the communication and the information message on the second user device. The second user device can include a user device that can access the second communications system. The receiving can be accomplished using compatible hardware, a plug-in component, an app, and so on. In embodiments, the receiving the communication and the information message can be accomplished by a client application running on the second user device. The client application can decode, translate, convert, or otherwise handle the communication and the information message. In embodiments, the receiving the communication and the information message can be accomplished by a standard PTT client. The PTT client can be owned by an individual or provided by an agency such as a public safety, emergency services, or government agency. The standard PTT client can include an unmodified PTT client, an industry standard client, a communications system-specific client, etc. Mentioned previously, the information message can include an MCData message. The receiving the communication and an MCData message can be accomplished by a client application running on the second user device, by a standard PTT client, and the like. The communication can include interoperable text messages that are augmented with TOS information, GPS information, and/or other data/metadata. Thus, the augmented text message communication can function similarly to an augmented interoperable voice call. In embodiments, the communication comprises a text message and the information message comprises one or more of TOS data, GPS data, and metadata. The flow 200 further includes recognizing 222, by the client application, if the MCData message includes the Talker ID. The MCData message can include mission-critical data, where the MCData can be associated with an event, a response to an event, and so on. Including Talker ID data with the MCData message can clearly identify a caller, verify the MCData message, etc.

The flow 200 can include displaying the Talker ID 230. The Talker ID can be displayed along with the communication (e.g., a text). When the communication is a call, the call can be enabled to the second user device. The call and the Talker ID can be associated with the first user device. The flow 200 further includes showing a text message 240 on the second user device. The text message can include a standard text message such as a text message originating from a smartphone or tablet, a message from a text-enabled PTT device, and so on. In the flow 200, the displaying is accomplished by a standard PTT client 242. The PTT client can include an issued handheld transceiver (HT), a mobile transceiver, a base station receiver, etc. In the flow 200, the text message includes the Talker ID 244 associated with the first user device. The Talker ID can include a username, a code, a team name, a team number, or other information that can identify the user of the first user device.

The flow 200 further includes replacing an ordinary user ID 250 from the first communications system with the Talker ID associated with the first user device. Recall that a Talker ID associated with the first user device that is using the first communications system may not be sent to the second user device using the second communications system since the first communications system and the second communications system are operated independently. As a result, a “common user” indication that masks or obscures the actual Talker ID can be displayed. By extracting the Talker ID text from the received text message, the common user ID can be replaced with the actual Talker ID, thus providing an accurate display of the caller from the first communications system. In the flow 200, the replacing 252 is accomplished by the client application running on the second user device. The client can be downloaded from an app store, provided by an agency such as a government agency, or offered by a service such as a public safety service. Additional information can also be handled by the client application. In embodiments, the Talker ID can be associated with a GPS location. The GPS location can be represented by degrees, minutes, and seconds; decimal degrees; and the like. The flow 200 further includes interpreting the GPS location 254. The interpreting can be accomplished by a client application. The GPS location can be interpreted from its representation in the message to alphanumeric characters that can be human readable. The flow 200 further includes showing 256, on the second user device, the GPS location of the first user device. The GPS location can be shown by displaying the alphanumeric representation of the GPS coordinates, by dropping a pin on a digital map, and so on. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

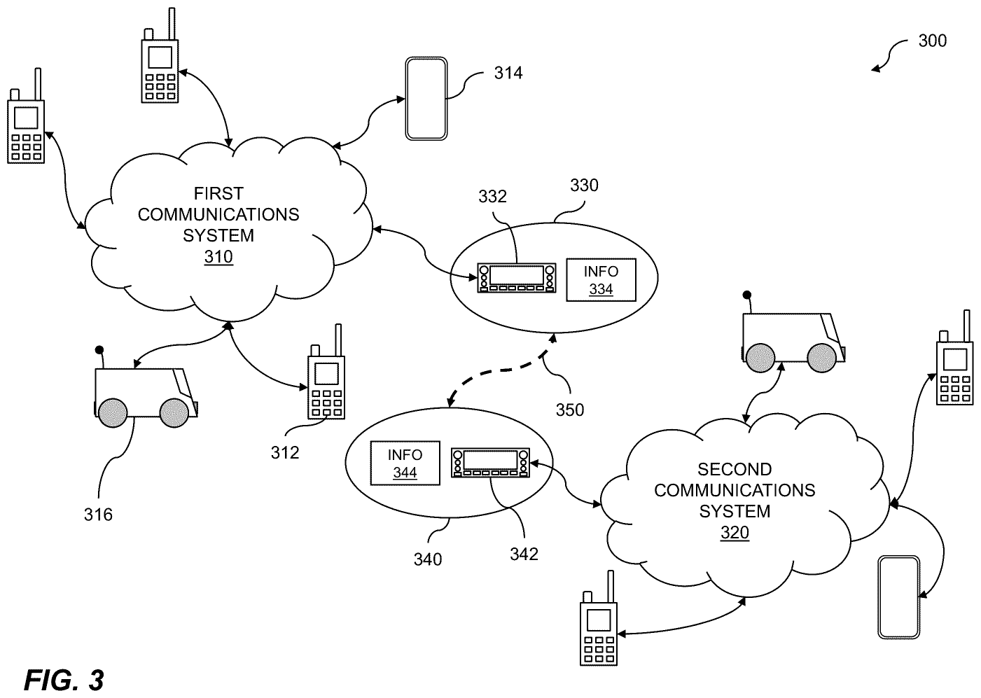

FIG. 3 is an infographic for sending TID data via a message. Discussed previously and throughout, Talker ID (TID) data can be shared between a first communications system and a second communications system. When a user device associated with the first communications system communicates with a user device associated with the second communications system, the Talker ID of the first user device is displayed on the second user device in a generic format. The generic format can include data associated with a common or “ordinary user”, but lacks detail about the user of the first user device. The detail that is lacking can include the talker on the originating system (TOS) data. The TOS data can include an actual Talker ID such as a username, code name, team name, tactical or TAC ID, radio ID, and so on. Using a text message to send TOS data from the first user device to the second user device enables sharing Talker ID data across communications networks. Push-to-talk (PTT) services are provided over a first communications system, wherein the first communications system includes a plurality of user devices. A Talker ID is associated with a first user device from the plurality of user devices on the first communications system, wherein the Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the Talker ID associated with the first user device are displayed on the second user device.

The infographic 300 can include a first communications or “comms” system 310. The first communications system can provide services such as push-to-talk (PTT) services. The push-to-talk services can include half-duplex, repeater, or similar operations. The communications system can use one or more frequency bands to enable communication. In embodiments, the communications system can be based on low-VHF, VHF, UHF, and similar bands. The bands that are used can include licensed and unlicensed spectra. The communications system can include one or more communications modes such as FM, narrowband FM, and so on. The communications modes can be based on analog or digital techniques. Various types of user devices can be associated with the first communications system. The infographic 300 can include a first user device 312. The first user device can be used by an individual to communicate with another individual, with a group such as a talk group, and so on. The communication can include audio, text, video, and the like. The first user device includes a handheld transceiver (HT), or “walkie talkie”. The HT can be configured to connect to the first communications system. In embodiments, the HT can connect to the communications system using one or more power levels, channels or frequencies, access tones or codes, and so on. In other embodiments, the first device can include a telephonic device such as a smartphone 314. A transceiver (not shown) can be coupled to the smartphone to connect to the first communications system. A transceiver app can be loaded onto the smartphone, where the app enables the smartphone to access the first communications system. In further embodiments, the first device can include a mobile transceiver 316. The mobile transceiver can be mounted in a vehicle such as a car, van, or truck; an aircraft such as a plane, helicopter, drone, or balloon; etc. One or more user devices of one or more user device types can be connected to the first communications system.

The various devices that are configured to access the first communications system can communicate among themselves. The communications within the first communications system can include one-to-one communication, where a first user device connects to a second user device. The communications within the first communications system can further include one-to-many communication, many-to-many communication, and so on. The communication among more than two user devices can include communication within a talk group. The user devices associated with a communications system such as the first communications system can communicate between and among themselves using a repeater, two or more linked repeaters, etc. The infographic 300 can include a second communications system 320. The second communications system can be substantially similar to or substantially different from the first communications system. The first communications system and the second communications systems can include LMR, LTE, or other communications systems. In embodiments, the first communications system and the second communications system are operated independently. The independently operated communications systems can be operated by governmental or emergency services, commercial enterprises, trained amateur operators, etc. Various user devices can communicate using the second communications system. The devices can include one or more user device types. The user device types can include HTs; smartphones coupled to transceivers, smartphones loaded with apps that enable communication using the second communication system, mobile user devices, etc.

The first communications system and the second communications system can be enabled using a controller such as a first controller 330 and a second controller 340. The first controller 330 associated with the first communications system can comprise a first transceiver 332 and a first information messenger 334. The transceiver can enable wireless communication from the first communications system to the controller, and to a link 350. In embodiments, the communication can include a text message, individual voice call, talkgroup voice call, information message, etc. The link can include a network, a back channel, one or more leased lines, the Internet, and so on. The channel can include a wired, wireless, or hybrid wired-wireless channel. The channel can include redundant communications paths. The information messenger 334 can provide an information message to the network. In embodiments, the information message can include a text message. The text message can include a Talker ID associated with a user device using the first communications system. The information generator can further receive information from another controller. The controller 340 associated with the second communications system can comprise a second transceiver 342 and a second information generator 344. The transceiver 342 can enable wireless communication from the second communications system to the controller, and to the link 350. The information generator can receive an information message from the information message generator 334. The message generator 344 can also generate information messages that can be sent to another communications controller such as 330. In embodiments, the receiving the communication and the information message can be accomplished by a client application running on the second user device, a standard PTT client, and so on. The received communication and the information message can be displayed on a device such as a user device associated with the second communications system. The information message can be used to provide key information such as Talker ID information associated with the first user device. In embodiments, the displaying can further include replacing, by the client application running on the second user device, an ordinary user ID from the first communications system with the Talker ID associated with the first user device. In embodiments, the first communications system 310 can be considered to include attached devices such as the first user device 312, the smartphone, the mobile transceiver 316, the first transceiver 332, and the first information messenger 334. In embodiments, the second communications system 320 can be considered to include attached devices such as user devices, smartphones, mobile transceivers, the second transceiver 342, the message generator 344, etc. In this manner, the link 350 enables communication between the first communications system 310 and the second communications system 320.

Using messaging to provide Talker ID routing between communications systems is described. Numerous communications scenarios exist in which a plurality of agencies require communications within each agency and between one or more additional agencies. Such scenarios include natural disasters, political unrest, terrorist attacks, and so on. Agencies such as public safety, emergency services, and government agencies must coordinate their responses to a given situation. Traditionally, interoperability between agencies was discouraged so as to avoid spurious communications by unauthorized personnel, to maintain channel integrity or security, and so on. However, after massive terrorist events such as 9/11 in the United States, 7/11 in Great Britain, and the November 2015 Paris attacks; and natural disasters such as Hurricane Katrina; an inability to communicate between and among agencies further complicated already complex situations. As a result, the ability to communicate among agencies became paramount. Complete replacement of existing communications systems was cost ineffective, so the ability to provide inter-communication system connectivity was sought instead. While users of different communications systems can be interconnected, key data such as Talker ID data is made generic, obscured, or even lost. In disclosed embodiments, information messages containing useful data such as Talker ID data and GPS data can be provided by one communications system to a second communications system. The information message can be provided without requiring a deep connection and an extensive system-to-system interface.

Communication information, including voice and state information such as emergency or mission-critical information, can be routed from a first communications system to a second communications system. Access between these communications systems can be accomplished by an ordinary user, which successfully enables communications but does not provide key information such as Talker ID. Providing Talker ID of the talking on the originating system (TOS) is highly desirable since such data confirms identify of a talker, enables access, and the like. A typical client user device such as a third-generation partnership project (3GPP)-compliant client can be used on a mission-critical push-to-talk (MCPTT) communications system. In embodiments, the 3GPP on an MCPTT communications system can make voice calls, send text messages, and send data messages such as such as mission-critical data (MCData) messages. The voice calls, text messages, and MCData messages can be sent to an individual, a talk group, and so on. These voice and data capabilities can enable sharing of Talker ID and other information between communications systems.

In a usage example, an individual accessing one communications system can initiate a call to an individual or a talk group in a second communications system. The call can be enabled by a typical 3GPP-client client. The 3GPP-compliant client can send an information message substantially simultaneously. In embodiments, the communication message, which can include a text message, can include the TOS information described above. The call and the text message can be received and displayed using hardware techniques, software techniques, and so on. In embodiments, an unmodified MCPTT client can have access to the data in the text message. The data can be rendered on a display associated with the MCPTT client. In further embodiments, an MCPTT client app can be used on various devices such as HTs, smartphones, and so on. The MCPTT client app can recognize that the text message contains TOS information, can suppress the message from being shown along with other standard text messages, and can “spoof” the Talker ID with the TOS data. The spoofing the Talker ID enables display of an actual Talker ID rather than a generic or “common” user Talker ID. The 3GPP-compliant client can also send an MCData message that includes the TOS information.

Further information can be sent from one communications system to a second communications system when initiating a 3GPP-compliant call, a text message, and so on. In embodiments, the further information can include global positioning system (GPS) data. The GPS data can include latitude and longitude information. The GPS data can include representation of the location of one or more user devices, where the representation can be unreadable by a human user. An app can be used to convert the GPS data into a usable format. The usable format can include rendering latitude and longitude using degrees, minutes, and seconds; decimal degrees such as Latitude: 43.893978 Longitude: −72.088991; and so on. The using a GPS format can include using the GPS coordinates to pin a location on a map. The map can include a standard map, a road map, a hybrid map, a contour map, a satellite map, and the like.

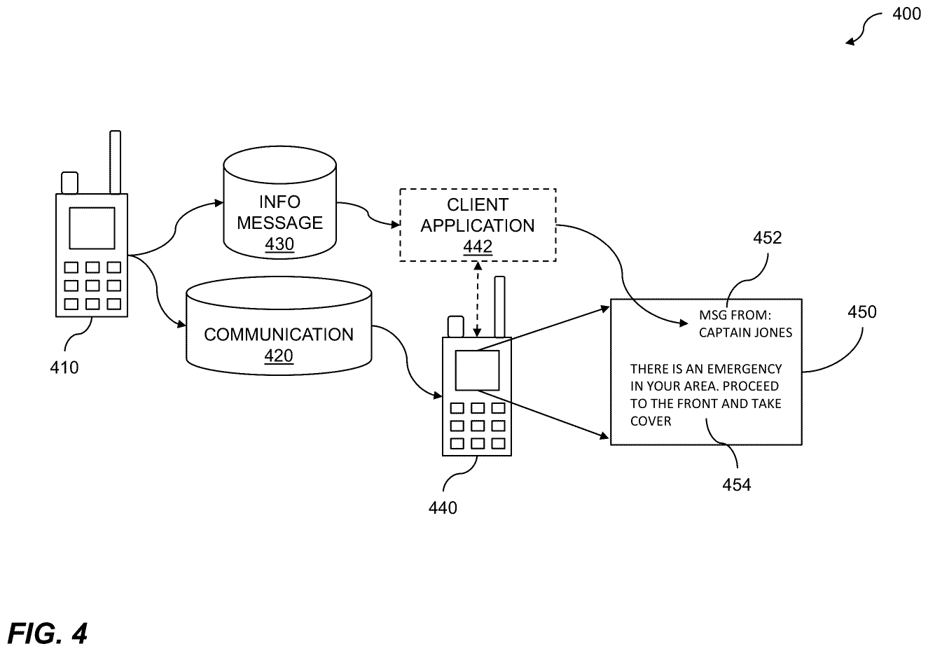

FIG. 4 is an infographic for displaying TID data via a PTT client application. Talker ID data can include identifying a user device. The user device can include a handheld or portable device, a mobile device, or a stationary or base station device. The Talker ID can include data that can identify the sending user device. The Talker ID can include various pieces of data such as a number, a code, a name, a user identifier, and so on. Typically, the Talker ID can be genericized or even omitted or lost entirely when a first user device that is accessing a first communications system is used to communicate with a second user device that is accessing a second communications system. The Talker ID can be shared across separate communications systems or networks using a communication and messaging technique. The communication and messaging technique enables sharing Talker ID across communications networks. The communication and messaging technique enables sharing Talker ID across communications networks. Push-to-talk (PTT) services are provided over a first communications system, wherein the first communications system includes a plurality of user devices. A Talker ID is associated with a first user device from the plurality of user devices on the first communications system, wherein the Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the Talker ID associated with the first user device are displayed on the second device.

The infographic 400 can include a first user device 410. The first user device can be used by an individual. The first user device can be used to communicate with a second individual, with a group of individuals such as a talk group, and so on. The first user device can use a first communications system. The first communications system can be based on a variety of services such as push-to-talk services, voice-activated services, and so on. The communication can include audio, text, graphics, video, and the like. The first user device can include a handheld transceiver (HT), or “walkie talkie”; a mobile transceiver; a base station transceiver; etc. The infographic 400 can include a communication 420. In embodiments, the communication can be a text message, individual voice call, or talkgroup voice call. The communication can also include audio tones such as continuous tone-coded squelch system (CTSS) tones, alerts, etc. The CTSS tones can open squelch on one or more user devices to enable communication between or among user devices. The communication can further include video. The infographic 400 can include an information message 430. In embodiments, the information message can include the Talker ID of the first user device. The information message can be provided in a variety of formats to meet one or more information message standards. In embodiments, the information message can include a text message. The text message can be sent from one user device to a second user device, to a group of user devices, and the like. In other embodiments, the information message can include a mission-critical data or MCData message. The MCData message can include those sent to or from governmental agencies; public safety agencies such as fire, police, and first responders; etc.

The communication can be sent from the first communication device to a second user device 440. The second communication device can be associated with or can access a second communications system. The second communications system can include a LMR, LTE, marine, satellite, or some other communications system. The information message is also provided from the first user device to the second user device. The second user device can receive the communication and the information message. In embodiments, the receiving the communication and the information message can be accomplished by a client application 442 running on the second user device. The client application can be downloaded from an app store; provided by a vendor, government, or public safety agency; etc. In a usage example, a user can download an app from the app store associated with their user device. The app can then receive messages, alerts such as severe weather or public safety alerts, etc. Discussed below, the receiving the communication and the information message can be accomplished by a standard PTT client. The standard PTT client can be designed, configured, etc., to handle the communication and the information message without the need for additional software, modification, and so on.

The infographic 400 can include an example screen 450 showing information message contents. The example screens include information that can be rendered on a display associated with the second user device 440. The display can be used to show second user device data such as communication channels, communication modes, remaining battery charge, service IDs, squelch levels, and so on. The display can be used to show a Talker ID 452. The display can be used to show a Talker ID, an alert, a message header, and so on, such as the mission-critical data (MCData) messages, and the like. The example screen can illustrate a message 454. The message can include text as shown, graphics such as a map or geolocation pin, video, etc. The message that is displayed can include a message to an individual user, users associated with a talk group, and so on. In embodiments, multiple fields from a message are displayed. More than one message can be displayed such as displaying multiple messages in a time-sequenced technique. The message screens can display data that was sent from the first user device in an encrypted format, where the data can then be decrypted by the second user device. The data that is displayed can be sent in an unencrypted format when appropriate. The data can be manipulated by compressing, encoding, and so on prior to sending it from the first user device to the second user device. The data can be manipulated to reduce bandwidth requirements.

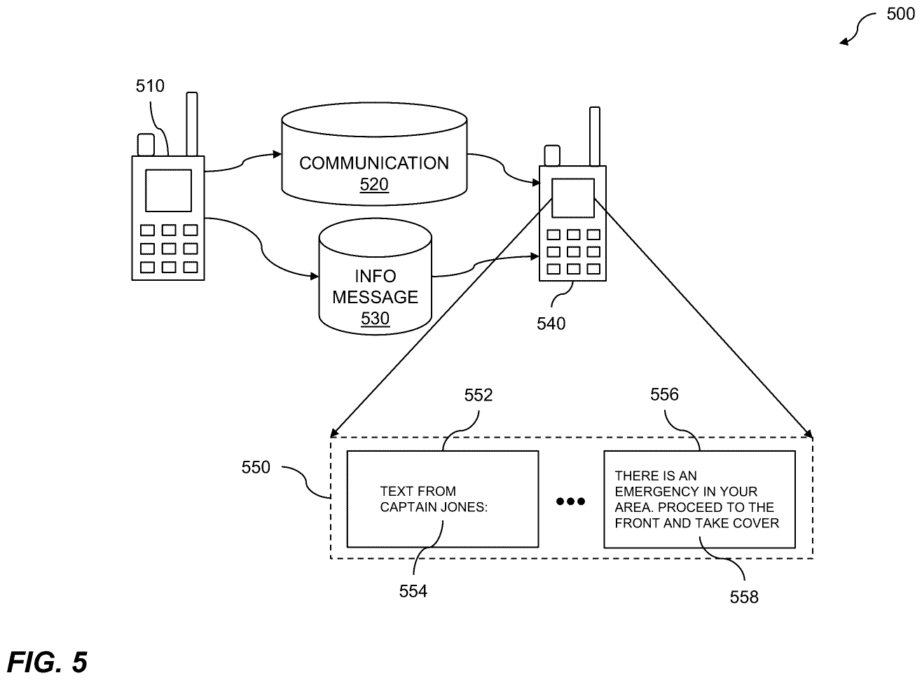

FIG. 5 is an infographic for displaying TID data via a standard PTT client. Talker ID data can include data that identifies a user device such as a handheld, mobile, or stationary device. The Talker ID can include a number, a code, a name, and so on. The Talker ID can be genericized or lost when a first user device is used to communicate with a second user device that is accessing a communications system which is different from the one accessed by the first user device. The Talker ID can be shared across communications systems or networks using a communication technique. The communication technique enables sharing Talker ID across communications networks. Push-to-talk (PTT) services are provided over a first communications system, wherein the first communications system includes a plurality of user devices. A Talker ID is associated with a first user device from the plurality of user devices on the first communications system, wherein the Talker ID uniquely identifies the first user device. A communication is sent from the first user device to a second user device on a second communications system. An information message is provided, from the first user device to the second user device, wherein the information message includes the Talker ID of the first user device. The communication and the information message are received on the second user device. The communication and the Talker ID associated with the first user device are displayed on the second device.

The infographic 500 can include a first user device 510. The first user device can be used by an individual to communicate with another individual, with a group such as a talk group, and so on. The first user device can use a first communications system, where the first communications system can be based on services such as push-to-talk services. The communication can include audio, text, video, and the like. The first user device can include a handheld transceiver (HT), a mobile transceiver, a base station transceiver, etc. The infographic 500 can include a communication 520. In embodiments, the communication can be a text message, individual voice call, or talkgroup voice call. The communication can also include CTSS tones, alerts, etc. The CTSS tones can open squelch on one or more user devices to enable communication between or among user devices. The infographic 500 can include an information message 530. In embodiments, the information message can include the Talker ID of the first user device. The information message can include a text message that can be sent from one user device to one or more other user devices. In other embodiments, the information message can include a mission-critical data (MCData) message. The MCData message can include a message sent to or from governmental agencies; public safety agencies such as fire, police, and first responders; etc.

The communication can be sent from the first communication device to a second user device 540. The second communication device can be associated with or be on a second communications system. The second communications system can include LMR, LTE, etc. The information message is also provided from the first user device to the second user device. The second user device can receive the communication and the information message. Discussed previously, the receiving the communication and the information message can be accomplished by a client application running on the second user device. The client application can be downloaded from an app store; provided by a vendor, government, or public safety agency; etc. In a usage example, a user can download an app from the app store associated with their user device. The app can then receive messages, alerts such as severe weather or public safety alerts, etc. In other embodiments, the receiving the communication and the information message can be accomplished by a standard PTT client. The standard PTT client can be designed, configured, etc., to handle the communication and the information message without the need for additional software, modification, and so on.

The infographic 500 can include example screens 550 of information that can be rendered on a display associated with the second user device 540. The display can be used to show second user device data such as channel, mode, remaining battery charge, and so on. The display can further be used to show Talker ID, messages such as the mission-critical data (MCData) messages, and the like. The example screens can include a first screenshot 552 which displays a message 554. The message can include text as shown, graphics, etc. The message that is displayed can include a message to an individual user, users associated with a talk group, and so on. A second example screenshot 556 is shown. The second screenshot shows additional information, where the additional information can relay further critical information 558, data, etc. While two example messages are shown, other numbers of messages can be displayed. The message screens can display data that was sent from the first user device in an encrypted format, where the data can then be decrypted by the second user device. The data that is displayed can be sent in an unencrypted format when appropriate. The data can be manipulated by compressing, encoding, and so on prior to sending from the first user device to the second user device. The data can be manipulated to reduce bandwidth requirements.

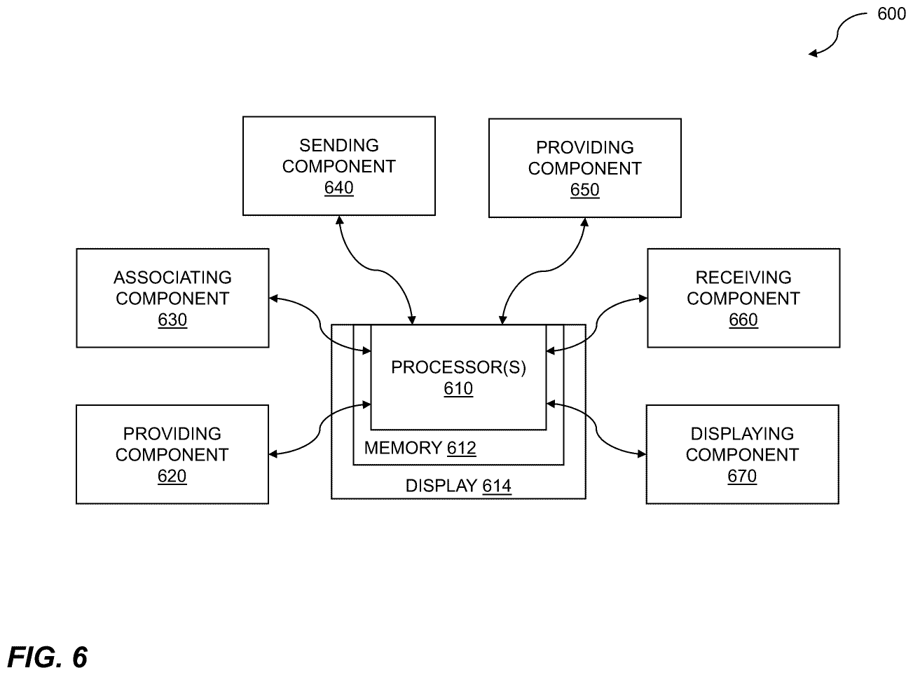

FIG. 6 is a system diagram for communications. Communications are enabled by sharing talker ID across communication systems. The system 600 can include one or more processors 610, which are coupled to a memory 612 which stores instructions. The system 600 can further include a display 614 coupled to the one or more processors 610 for displaying data such as one or more talker IDs, intermediate steps, GPS data, and so on. In embodiments, one or more processors 610 are coupled to the memory 612, wherein the one or more processors, when executing the instructions which are stored, are configured to: provide push-to-talk (PTT) services over a first communications system, wherein the first communications system includes a plurality of user devices; associate a Talker ID with a first user device from the plurality of user devices on the first communications system, wherein the Talker ID uniquely identifies the first user device; send a communication from the first user device to a second user device on a second communications system; provide an information message, from the first user device to the second user device, wherein the information message includes the Talker ID of the first user device; receive the communication and the information message on the second user device; and display, on the second user device, the communication and the Talker ID associated with the first user device. The communication can include a text message, individual voice call, or talkgroup voice call. The receiving the communication and the information message can be accomplished by a client application running on the second user device.

The system 600 can include a providing component 620. The providing component 620 can include logic and functions for providing push-to-talk (PTT) services over a first communications system, wherein the first communications system includes a plurality of user devices. The first communications system can include a wireless communications system such as a land mobile radio (LMR) communications system. The LMR communications system can enable communication among government and emergency services, enterprises, and individuals, etc. The wireless communications system can be based on low-VHF frequencies, VHF frequencies, UHF frequencies, and so on. The system can access licensed and unlicensed communications bands. The communications systems can include analog modes such as FM and narrow band FM, digital modes such as Next Generation Digital Narrowband (NXDN™) and Project 25 (P25), and the like. In embodiments, the communications channels can include encrypted and unencrypted communications. The plurality of user devices can include handheld devices such as handheld transceivers (HTs) or walkie-talkies, mobile transceivers, repeaters, base stations, etc. The user devices can also include telephonic devices such as a smartphone, where the smartphone can be loaded with a communications app or similar software. In embodiments, the first user device can be Third Generation Partnership Project (3GPP)-compliant. 3GPP-compliance can enable radio access technologies such as Universal Terrestrial Radio Access™ (UTRA), Frequency Division Duple (FDD), etc.

The system 600 can include an associating component 630. The associating component 630 can associate a Talker ID with a first user device from the plurality of user devices on the first communications system, wherein the Talker ID uniquely identifies the first user device. The Talker ID can include a name, a code name, a team name, team member number, a radio number, and so on. The Talker ID can be associated with a user by an employer, a team leader, another user, etc. The Talker ID can be used as a code to unblock or enable communications between users, to enable access to a talk group, and so on. The Talker ID can contain other information associated with the first user device. In embodiments, the Talker ID can include a GPS location.

The system 600 can include a sending component 640. The sending component 640 can send a communication from the first user device to a second user device on a second communications system. The communication can include data such as alphanumeric data, audio data such as continuous tone-coded squelch system (CTSS) tones, and the like. In embodiments, the communication can include a text message, an individual voice call, a talkgroup voice call, etc. The second user device can be substantially similar to the first user device or substantially different from the first user device. The second user device can include a handheld device, a mobile device, and a base station or stationary device. The second user device can include a smartphone or other telecommunication device. The second communications system can be substantially similar to or substantially different from the first communications system. In embodiments, the first communications system and the second communications system can be based on Land Mobile Radio technology (LMR). Discussed previously, the LMR radio technology can be based on VHF and UHF frequencies, can include analog and digital modes, and so on. In embodiments, the first communications system is based on LTE technology and the second communications system is based on LMR technology. The LTE technology can include 5G technology. The first communications system and the second communications system can further be based on GSM technology, VHF marine radio, satellite communications, etc. In further embodiments, the first communications system is based on LMR technology, and the second communications system is based on LTE technology. The sending a communication enables a connection among a plurality of user devices. In embodiments, the sending a communication can include sending the communication to a talk group on the second communications system.

The system 600 can include a providing component 650. The providing component 650 can provide an information message, from the first user device to the second user device, wherein the information message includes the Talker ID of the first user device. The information can include one or more characters such as alphanumeric characters. In embodiments, the information message can include a text message. The number of alphanumeric characters in the information message can include a fixed or variable number of characters, a limited number of characters, and so on. The information message can be based on one or more text message standards. In embodiments, the information message can include a mission critical data (MCData) message. An MCData service can include messaging data, transferred file data, streaming data, and the like. An MCData service can, in addition to providing various data types, also provide conversation management between individuals and talk groups, database inquiries, internet and intranet access, etc.

The system 600 can include a receiving component 660. The receiving component can receive the communication and the information message on the second user device. The second user device can include a handheld, mobile, or base station device, a smartphone, etc. The communication and the information can be directed or routed specifically to the second device, to a device among a talk group of devices, to a talk group, and so on. The communication and the information message can be received using a device designed for use with the second communications system, using software running on the second device, and so on. In embodiments, the receiving the communication and the information message can be accomplished by a client application running on the second user device. The client application can be downloaded from an application service or store, provided by an operator of the second communications system, provided by a governmental or emergency services agency, etc. In embodiments, the receiving the communication and the information message can be accomplished by a standard PTT client. The standard PTT client can be designed for one or more communications systems such as the second communications system. Mentioned previously, the information message can include an MCData message. In embodiments, the receiving the communication and the information message can be accomplished by a client application running on the second user device. The application can be used to recognize that the information message is an MCData message. Embodiments further include recognizing, by the client application, if the MCData message includes the Talker ID. The recognizing can be used for displaying purposes, discussed below. In embodiments, the receiving the communication and the information message is accomplished by a standard PTT client. The information message received by the standard PTT client can include an MCData message.

The system 600 can include a displaying component 670. The displaying component 670 can display, on the second user device, the communication and the Talker ID associated with the first user device. The display can include an LCD, OLED, LED, or similar display. The display can display one or more of alphanumeric characters, graphics, video, and so on. The display can include a monochrome, grayscale, or color display, etc. In embodiments, the displaying further comprises replacing, by the client application running on the second user device, an ordinary user ID from the first communications system with the Talker ID associated with the first user device. The ordinary user ID can be nonspecific as to the actual user of the first user device if the second user device is using a communications system different from the communications system used by the first device. By using the application on the second device, the Talker ID can be displayed instead of the ordinary user ID, thereby providing accurate identification, verifying identify of the first user, etc. In other embodiments, the displaying further comprises showing text on the second user device, wherein the text includes the Talker ID associated with the first user device. The text message can be displayed alone; with second user device information such as channel, signal strength, remaining battery charge; etc. In embodiments, the displaying can further include replacing, by the client application running on the second user device, an ordinary user ID from the first communications system with the Talker ID associated with the first user device. The displaying the Talker ID can be associated with recognizing if an MCData message includes the Talker ID. In other embodiments, the displaying can further include showing a text message, on the second user device, wherein the text message includes the Talker ID associated with the first user device. The text message can be used to exchange the Talker ID even when the first communications system does not transfer the Talker ID information to the second communications system. Further embodiments can include interpreting, by a client application, the GPS location of the first device user. The GPS coordinates can include degrees of latitude and longitude, a pin on a map, and so on. Further embodiments include showing, on the second user device, the GPS location of the first user device.

The system 600 can include a computer program product embodied in a non-transitory computer readable medium for communications, the computer program product comprising code which causes one or more processors to perform operations of: providing push-to-talk (PTT) services over a first communications system, wherein the first communications system includes a plurality of user devices; associating a Talker ID with a first user device from the plurality of user devices on the first communications system, wherein the Talker ID uniquely identifies the first user device; sending a communication from the first user device to a second user device on a second communications system; providing an information message, from the first user device to the second user device, wherein the information message includes the Talker ID of the first user device; receiving the communication and the information message on the second user device; and displaying, on the second user device, the communication and the Talker ID associated with the first user device.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for communications comprising:
providing push-to-talk (PTT) services over a first communications system, wherein the first communications system includes a plurality of user devices;
associating a Talker ID with a first user device from the plurality of user devices on the first communications system, wherein the Talker ID uniquely identifies the first user device;
sending a communication from the first user device to a second user device on a second communications system;
providing an information message, from the first user device to the second user device, wherein the information message includes the Talker ID of the first user device;
receiving the communication and the information message on the second user device; and
displaying, on the second user device, the communication and the Talker ID associated with the first user device.

2. The method of claim 1 wherein the communication is a text message, individual voice call, or talkgroup voice call.

3. The method of claim 2 wherein the receiving the communication and the information message is accomplished by a client application running on the second user device.

4. The method of claim 3 wherein the displaying further comprises replacing, by the client application running on the second user device, an ordinary user ID from the first communications system with the Talker ID associated with the first user device.

5. The method of claim 2 wherein the receiving the communication and the information message is accomplished by a standard PTT client.

6. The method of claim 5 wherein the displaying further comprises showing text on the second user device, wherein the text includes the Talker ID associated with the first user device.

7. The method of claim 1 wherein the information message comprises a text message.

8. The method of claim 1 wherein the information message comprises a mission critical data (MCData) message.

9. The method of claim 8 wherein the receiving the communication and the information message is accomplished by a client application running on the second user device.

10. The method of claim 9 further comprising recognizing, by the client application, if the MCData message includes the Talker ID.

11. The method of claim 10 wherein the displaying further comprises replacing, by the client application running on the second user device, an ordinary user ID from the first communications system with the Talker ID associated with the first user device.

12. The method of claim 8 wherein the receiving the communication and the information message is accomplished by a standard PTT client.

13. The method of claim 12 wherein the displaying further comprises showing a text message, on the second user device, wherein the text message includes the Talker ID associated with the first user device.

14. The method of claim 1 wherein the Talker ID includes Talker ID information and a GPS location.

15. The method of claim 14 further comprising interpreting, by a client application, the GPS location.

16. The method of claim 15 further comprising showing, on the second user device, the GPS location of the first user device.

17. The method of claim 1 wherein the first communications system and the second communications system are based on Land Mobile Radio technology (LMR).

18. The method of claim 1 wherein the first communications system is based on LTE technology and the second communications system is based on LMR technology.

19. The method of claim 1 wherein the first communications system is based on LMR technology, and the second communications system is based on LTE technology.

20. (canceled)

21. The method of claim 1 wherein the first user device is 3GPP-compliant.

22. The method of claim 1 wherein the sending a communication includes sending the communication to a talk group on the second communications system.

23. The method of claim 1 wherein the push-to-talk services comprise mission critical push-to-talk services.

24. The method of claim 1 wherein the Talker ID identifies a talker on an originating system (TOS).

25. The method of claim 1 wherein the first communications system and the second communications system are operated independently.

26. (canceled)

27. A computer program product embodied in a non-transitory computer readable medium for communications, the computer program product comprising code which causes one or more processors to perform operations of:
providing push-to-talk (PTT) services over a first communications system, wherein the first communications system includes a plurality of user devices;
associating a Talker ID with a first user device from the plurality of user devices on the first communications system, wherein the Talker ID uniquely identifies the first user device;
sending a communication from the first user device to a second user device on a second communications system;
providing an information message, from the first user device to the second user device, wherein the information message includes the Talker ID of the first user device;
receiving the communication and the information message on the second user device; and
displaying, on the second user device, the communication and the Talker ID associated with the first user device.

28. A computer system for communications comprising:
a memory which stores instructions;
one or more processors coupled to the memory wherein the one or more processors, when executing the instructions which are stored, are configured to:
provide push-to-talk (PTT) services over a first communications system, wherein the first communications system includes a plurality of user devices;
associate a Talker ID with a first user device from the plurality of user devices on the first communications system, wherein the Talker ID uniquely identifies the first user device;
send a communication from the first user device to a second user device on a second communications system;
provide an information message, from the first user device to the second user device, wherein the information message includes the Talker ID of the first user device;
receive the communication and the information message on the second user device; and
display, on the second user device, the communication and the Talker ID associated with the first user device.
